(19) United States
(12) Patent Application Publication
(10) Pub. No.: US 2023/0096786 A1
(43) Pub. Date: Mar. 30, 2023

(54) APPARATUS AND METHOD FOR A CABLE CONVEYANCE ASSEMBLY

(71) Applicant: Jonathan Eric Crosland, Ringgold, GA (US)

(72) Inventor: Jonathan Eric Crosland, Ringgold, GA (US)

(21) Appl. No.: 17/951,853

(22) Filed: Sep. 23, 2022

Related U.S. Application Data
(60) Provisional application No. 63/247,536, filed on Sep. 23, 2021.

(51) Int. Cl. H02G 1/08; H02G 1/02

(52) U.S. Cl. CPC H02G 1/081; H02G 1/02

(57) ABSTRACT

A cable conveyance attachment assembly adapted to be operatively connected to a host vehicle and a length of cable. The assembly includes a frame, a mounting plate that is attached to the frame, at least one drum that is rotationally attached to the frame, and a fluid conduit that is operatively connected to the host vehicle and the at least one drum. The at least one drum is adapted to pull the length of cable, and the mounting plate is adapted to removably attach the cable conveyance attachment assembly to the host vehicle. A method for conveying cable including providing a cable conveyance attachment assembly and conveying the length cable to at least one drum.

### CROSS-REFERENCES TO RELATED APPLICATIONS/PATENTS

This application relates back to and claims the benefit of priority from U.S. Provisional Application for Pat. Serial No. 63/247,536 titled “Cable Stringing Attachment” and filed on Sep. 23, 2021.

### FIELD OF THE INVENTION

The present invention relates generally to apparatuses and methods for cable conveyance systems, and particularly to apparatuses and methods for over-head and underground cable conveyance systems.

### BACKGROUND AND DESCRIPTION OF THE PRIOR ART

It is known to use apparatuses and methods to convey cable. Conventional apparatuses and methods, however, suffer from one or more disadvantages. For example, conventional cable conveyance apparatuses and methods are undesirably immobile and lack transportability. Conventional cable conveyance apparatuses and methods also undesirably lack accessibility. Further, conventional cable conveyance apparatuses and methods are undesirably inefficient and require excessive time and labor to convey cable. Still further, conventional cable conveyance apparatuses and methods are expensive to manufacture, maintain, and repair. In addition, conventional cable conveyance apparatuses require numerous components, and therefore, are undesirably complex and complicated. Conventional cable conveyance apparatuses and methods also undesirably require an on-board power supply and are difficult to use and position.

It would be desirable, therefore, if an apparatus and method for a cable conveyance assembly could be provided that would be sufficiently mobile and transportable. It would also be desirable if such an apparatus and method for a cable conveyance assembly could be provided that would be sufficiently accessible. It would be further desirable if such an apparatus and method for a cable conveyance assembly could be provided that would be sufficiently efficient and require less time and labor to convey cable. It would be still further desirable if such an apparatus and method for a cable conveyance assembly could be provided that would be less expensive to manufacture, maintain, and repair. In addition, it would be desirable if such an apparatus and method for a cable conveyance assembly could be provided that would require fewer components, and therefore, be less complex and complicated. It would also be desirable if such an apparatus and method for a cable conveyance assembly could be provided that would not require an on-board power supply and would be less difficult to use and position.

Accordingly, it is an advantage of the preferred embodiments of the invention claimed herein to provide an apparatus and method for a cable conveyance assembly that is sufficiently mobile and transportable. It is also an advantage of the preferred embodiments of the invention claimed herein to provide an apparatus and method for a cable conveyance assembly that is sufficiently accessible. It is another advantage of the preferred embodiments of the invention claimed herein to provide an apparatus and method for a cable conveyance assembly that is sufficiently efficient and requires less time and labor to convey cable. It is still another advantage of the preferred embodiments of the invention claimed herein to provide an apparatus and method for a cable conveyance assembly that is less expensive to manufacture, maintain, and repair. It is yet another advantage of the preferred embodiments of the invention claimed herein to provide an apparatus and method for a cable conveyance assembly that requires fewer components, and therefore, is less complex and complicated. In addition, it is an advantage of the preferred embodiments of the invention claimed herein to provide an apparatus and method for a cable conveyance assembly that does not require an on-board power supply and is less difficult to use and position.

Additional advantages of the preferred embodiments of the invention will become apparent from an examination of the drawings and the ensuing description.

### EXPLANATION OF THE TECHNICAL TERMS

The use of the terms “a,” “an,” “the,” and similar terms in the context of describing the invention are to be construed to cover both the singular and the plural, unless otherwise indicated herein or clearly contradicted by context. The terms “comprising” “having,” “including,” and “containing” are to be construed as open-ended terms (i.e., meaning “including, but not limited to,”) unless otherwise noted. The terms “substantially,” “generally,” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic. All methods described herein can be performed in any suitable order unless otherwise specified herein or clearly indicated by context.

Terms concerning attachments, coupling and the like, such as “attached,” “connected,” and “interconnected,” refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of all examples or exemplary language (e.g., “such as,” “preferred,” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity. Several terms are specifically defined herein. These terms are to be given their broadest reasonable construction consistent with such definitions, as follows:

As used herein, the term “actuator” means any device, mechanism, assembly or combination thereof that is adapted to move or be moved between a retracted position and an extended position to impart a mechanical force. The term “actuator” includes without limitation linear actuators, rotary actuators, hydraulic cylinders, hydraulic rotary actuators, pneumatic cylinders, springs and the like.

As used herein, the term “conduit” means any device, mechanism, assembly or combination thereof that is adapted to permit cable, fluids, or other materials to pass through it or them. The term “conduit” includes, without limitation, pipes, tubes, channels, troughs, and/or other passages.

### SUMMARY OF THE INVENTION

The apparatus of the invention comprises a cable conveyance attachment assembly adapted to be operatively connected to a host vehicle and a length of cable. The preferred assembly comprises a frame, a mounting plate that is attached to the frame, at least one drum that is rotationally attached to the frame, and a fluid conduit that is operatively connected to the host vehicle and the at least one drum. Preferably, the at least one drum is adapted to pull the length of cable, and the mounting plate is adapted to removably attach the cable conveyance attachment assembly to the host vehicle.

The method of the invention comprises a method for conveying cable. The preferred method comprises providing a cable conveyance attachment assembly adapted to be operatively connected to a host vehicle and a length of cable. The preferred assembly comprises a frame, a mounting plate that is attached to the frame, at least one drum that is rotationally attached to the frame, and a fluid conduit that is operatively connected to the host vehicle and the at least one drum. Preferably, the at least one drum is adapted to pull the length of cable, and the mounting plate is adapted to removably attach the cable conveyance attachment assembly to the host vehicle. The preferred method further comprises conveying the length of cable to the at least one drum.

### BRIEF DESCRIPTION OF THE DRAWINGS

The presently preferred embodiments of the invention are illustrated in the accompanying drawings, in which like reference numerals represent like parts throughout, and in which:

FIG. 1 is a plan view of the preferred embodiment of the cable conveyance system in accordance with the present invention illustrating an above-ground application.

FIG. 2 is a plan view of a first alternative embodiment of the preferred cable conveyance system in accordance with the present invention illustrating an underground application.

FIG. 3 is a perspective view of the preferred cable conveyance attachment assembly mounted on a tracked loader in accordance with the present invention.

FIG. 4 is a right side view of the preferred cable conveyance attachment assembly mounted on a tracked loader illustrated in FIG. 3.

FIG. 5 is an isolated front perspective view of the preferred cable conveyance attachment assembly illustrated in FIGS. 3-4.

FIG. 6 is an exploded front perspective view of the preferred cable conveyance attachment assembly illustrated in FIGS. 3-5.

FIG. 7 is an isolated back perspective view of the preferred cable conveyance attachment assembly illustrated in FIGS. 3-6.

FIG. 8 is an isolated rear view of the preferred cable conveyance attachment assembly illustrated in FIGS. 3-7.

FIG. 9 is an isolated left side view of the preferred cable conveyance attachment assembly illustrated in FIGS. 3-8.

FIG. 10 is an isolated front perspective view of the preferred level wind mount of the cable conveyance attachment assembly illustrated in FIGS. 3-9.

FIG. 11 is an isolated right side view of the preferred level wind mount of the cable conveyance attachment assembly illustrated in FIGS. 3-10.

FIG. 12 is an isolated perspective view of the threaded shaft and threaded sheave of the level wind assembly illustrated in FIGS. 3-11.

FIG. 13 is an exploded perspective view of the threaded shaft and threaded sheave of the level wind assembly illustrated in FIGS. 3-12.

FIG. 14 is an isolated front view of the threaded shaft and threaded sheave of the level wind assembly illustrated in FIGS. 3-13.

FIG. 15 is an isolated back perspective view of the preferred mounting plate of the cable conveyance attachment assembly illustrated in FIGS. 3-14.

### DESCRIPTION OF THE PREFERRED EMBODIMENTS OF THE INVENTION

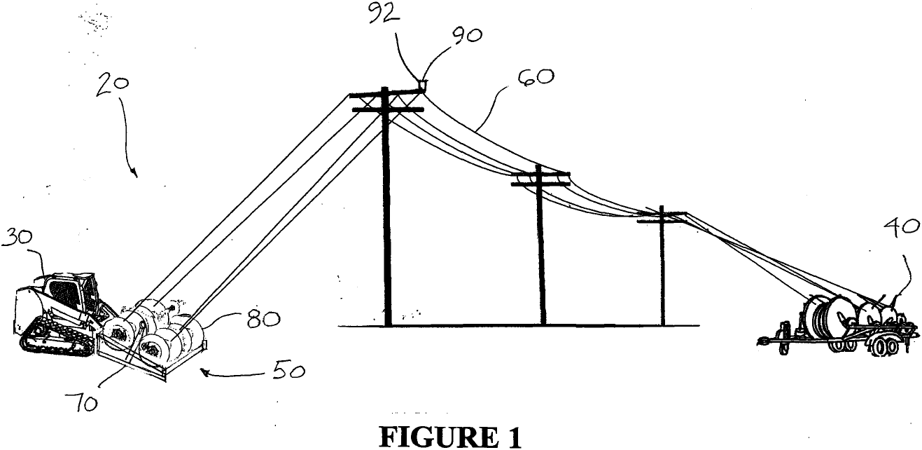

Referring now to the drawings, the preferred embodiments of the cable conveyance system in accordance with the present invention are illustrated by FIGS. 1 through 15. Referring now to FIG. 1, a plan view of the preferred embodiment of the cable conveyance system in accordance with the present invention is illustrated in an above-ground application. As shown in FIG. 1, the preferred cable conveyance system is designated generally by reference numeral 20. Preferred cable conveyance system 20 comprises a host vehicle such as tracked loader 30, tensioning assembly 40, and cable conveyance attachment assembly 50. Preferred tensioning assembly 40 is spaced a distance apart from host vehicle 30 and is adapted to removably store a length of cable 60. Preferred cable conveyance attachment assembly 50 is adapted to be operatively connected to tracked loader 30 and length of cable 60. Preferred cable conveyance attachment assembly 50 comprises frame 70 and a plurality of drums 80 which are rotationally attached to the frame. Preferred plurality of drums 80 are adapted to pull length of cable 60. Preferred cable conveyance system 20 also comprises pulley assembly 90 and block assembly 92. Preferred cable conveyance system 20 further comprises pulling rope 100 having pulling rope first end 102 and pulling rope second end 104 which is operatively connected to length of cable 60. Preferred pulling drum 80 is adapted to receive pulling rope 100, which in turn pulls length of cable 60 into proper position on the power poles.

While FIG. 1 illustrates the preferred configuration and arrangement of the cable conveyance system in an above-ground application, it is contemplated with the scope of the invention that the cable conveyance system may be of any suitable configuration or arrangement. In addition, it is also contemplated within the scope of the invention that the host vehicle may be a wheeled loader or any other suitable host vehicle.

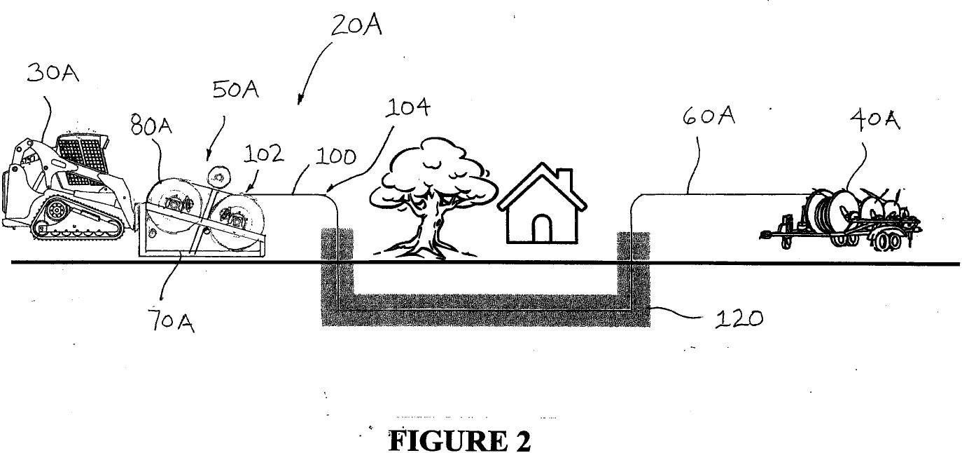

Referring now to FIG. 2, a plan view of a first alternative embodiment of the preferred cable conveyance system in accordance with the present invention is illustrated in an underground application. As shown in FIG. 2, the preferred cable conveyance system is designated generally by reference numeral 20A. Preferred cable conveyance system 20A comprises host vehicle such as tracked loader 30A, tensioning assembly 40A, and cable conveyance attachment assembly 50A. Preferred tensioning assembly 40A is spaced a distance from host vehicle 30A and is adapted to removably store a length of cable 60A. Preferred cable conveyance attachment assembly 50A is adapted to be operatively connected to tracked loader 30A and length of cable 60A. Preferred cable conveyance attachment assembly 50A comprises frame 70A and a plurality of drums 80A which are rotationally attached to the frame. Preferred plurality of drums 80A are adapted to pull length of cable 60A. Preferred cable conveyance system 20A also comprises pulling rope 100 having pulling rope first end 102 which is operatively connected to one of the plurality of drums 80A and pulling rope second end 104 which is operatively connected to length of cable 60A. Preferred cable conveyance system 20A further comprises cable conduit 120. Preferred pulling drums 80A are adapted to receive pulling rope 100A, which in turn pulls length of cable 60A into proper position in conduit 120. While FIG. 2 illustrates the preferred configuration and arrangement of the cable conveyance system in an underground application, it is contemplated with the scope of the invention that the cable conveyance system may be of any suitable configuration or arrangement.

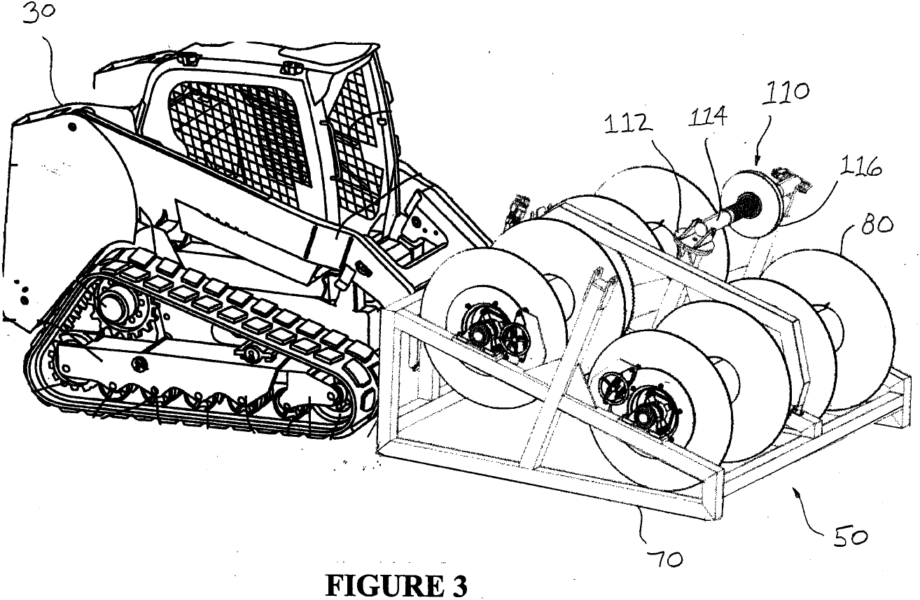

Referring now to FIG. 3, a perspective view of preferred cable conveyance attachment assembly 50 mounted on tracked loader 30 is illustrated. As shown in FIG. 3, preferred cable conveyance attachment assembly 50 comprises frame 70 and a plurality of drums 80. Preferred cable conveyance attachment assembly 50 is attached to frame 70 and further comprises level wind assembly 110 having level wind mount 112 and a means for adjusting the level wind assembly such as threaded shaft 114 and threaded sheave 116. While threaded shaft 114 and threaded sheave 116 are the preferred means for adjusting the level wind assembly, it is contemplated within the scope of the invention that the means for adjusting the level wind assembly may be any suitable device, mechanism, assembly, or combination thereof such as an actuator and the like.

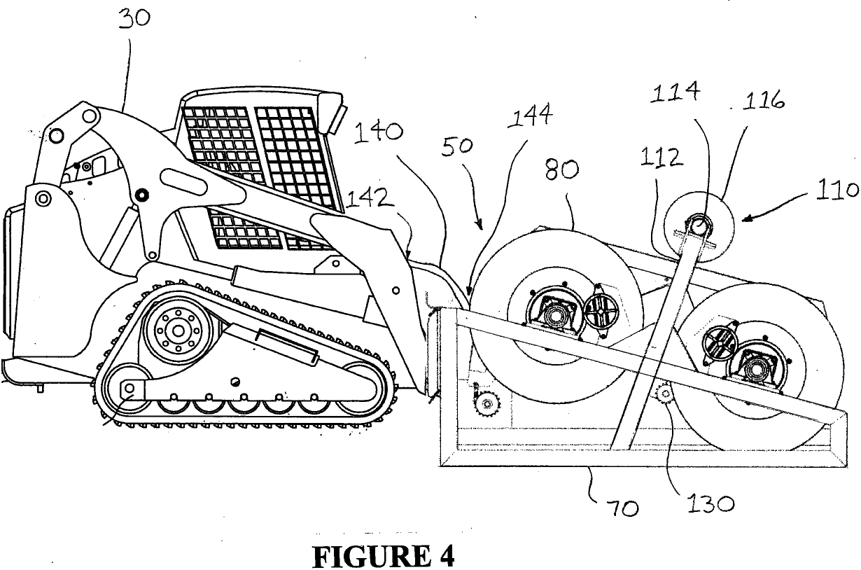

Referring now to FIG. 4, a right side view of preferred cable conveyance attachment assembly 50 mounted on tracked loader 30 is illustrated. As shown in FIG. 4, preferred cable conveyance attachment assembly 50 comprises frame 70, a plurality of drums 80, and level wind assembly 110 having level wind mount 112, threaded shaft 114, and threaded sheave 116. Preferred cable conveyance attachment assembly 50 also comprises chain tensioner 130 and a fluid conduit such as hydraulic hose 140 having hydraulic hose first end 142 which is operatively connected to tracked loader 30 and hydraulic hose second end 144 which is operatively connected to at least one of the plurality of drums. More particularly, hydraulic hose second end 144 is operatively connected to preferred pulling drum 80 via a hydraulic motor, a sprocket, a chain, a driveshaft, and a pin. While FIG. 4 illustrates the preferred configuration and arrangement of the fluid conduit, it is contemplated within the scope of the invention that the fluid conduit may be of any suitable configuration and arrangement such as a pneumatic hose and the like.

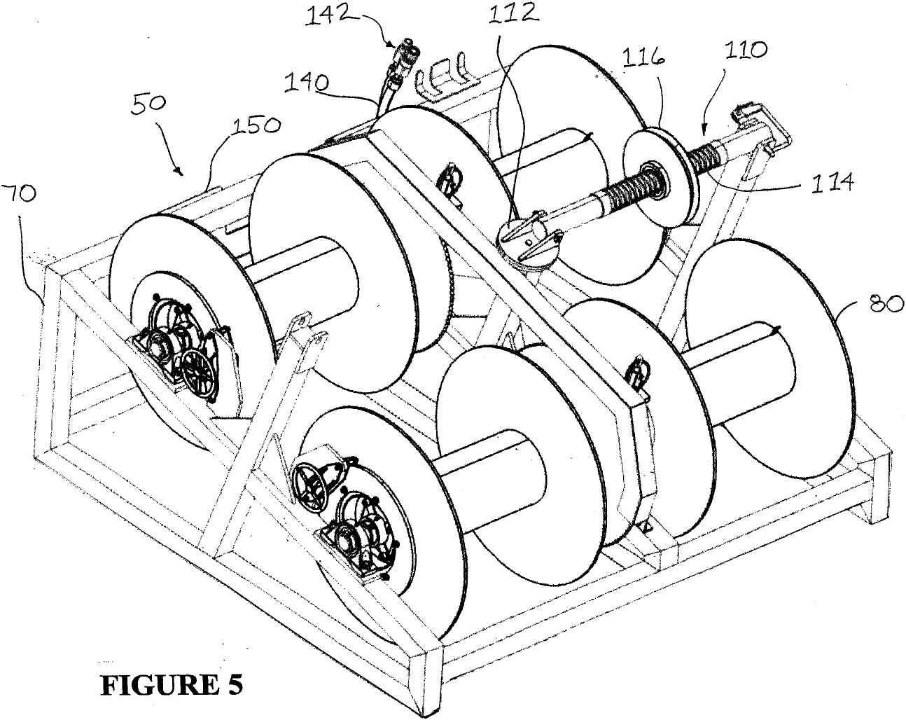

Referring now to FIG. 5, an isolated front perspective view of preferred cable conveyance attachment assembly 50 is illustrated. As shown in FIG. 5, preferred cable conveyance attachment assembly 50 comprises frame 70, plurality of drums 80, level wind assembly 110 having level wind mount 112, threaded shaft 114, and threaded sheave 116, hydraulic hose 140 having hydraulic hose first end 142, and mounting plate 150.

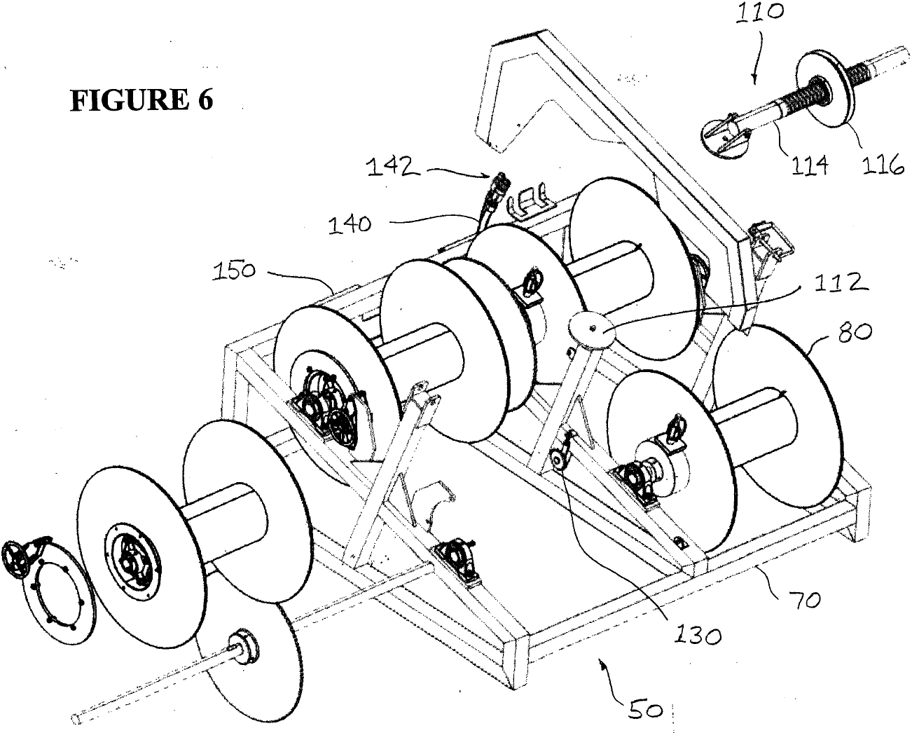

Referring now to FIG. 6, an exploded front perspective view of preferred cable conveyance attachment assembly 50 is illustrated. As shown in FIG. 6, preferred cable conveyance attachment assembly 50 comprises frame 70, plurality of drums 80, level wind assembly 110 having level wind mount 112, threaded shaft 114, and threaded sheave 116, chain tensioner 130, hydraulic hose 140 having hydraulic hose first end 142, and mounting plate 150.

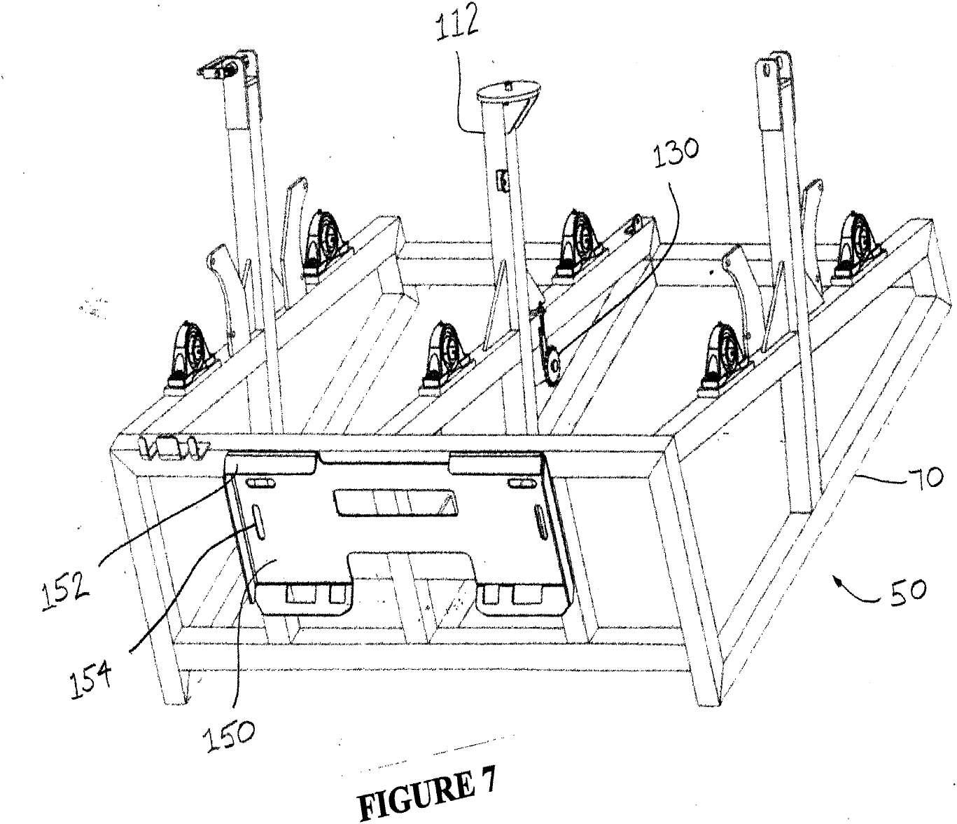

Referring now to FIG. 7, an isolated back perspective view of preferred cable conveyance attachment assembly 50 is illustrated. As shown in FIG. 7, preferred cable conveyance attachment assembly 50 comprises frame 70, level wind mount 112, chain tensioner 130, and mounting plate 150. Preferred mounting plate 150 is adapted to be attached to frame 70 and to removably attach cable conveyance attachment assembly 50 to the host vehicle. More particularly, preferred mounting plate 150 comprises an attachment means having at least one flange 152 and at least one opening 154.

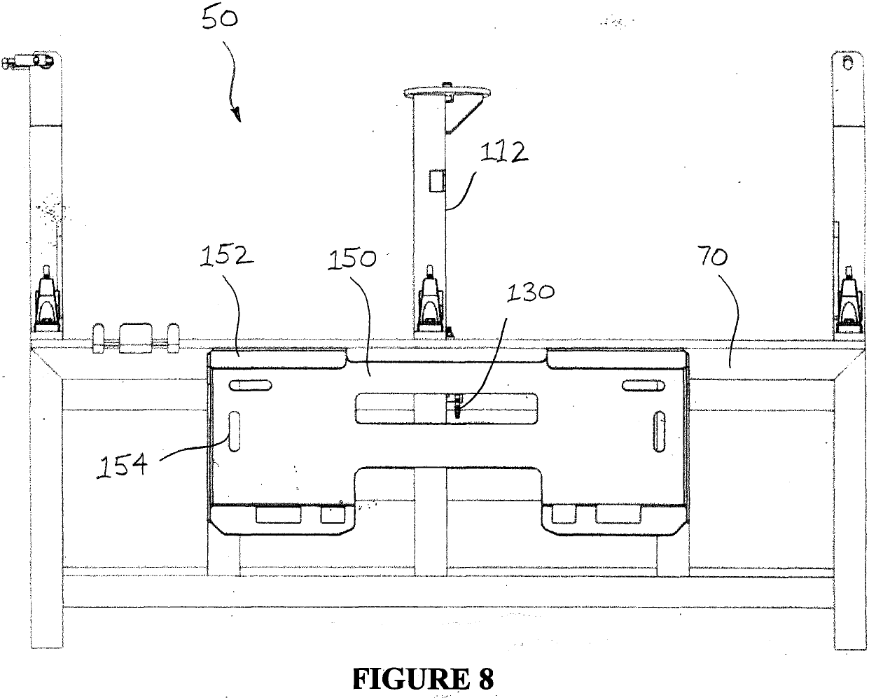

Referring now to FIG. 8, an isolated rear view of preferred cable conveyance attachment assembly 50 is illustrated. As shown in FIG. 8, preferred cable conveyance attachment assembly 50 comprises frame 70, level wind mount 112, chain tensioner 130, mounting plate 150, flanges 152, and openings 154.

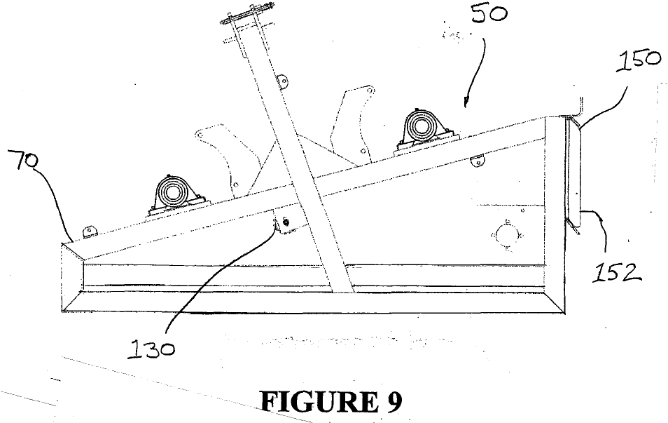

Referring now to FIG. 9, an isolated left side view of preferred cable conveyance attachment assembly 50 is illustrated. As shown in FIG. 9, preferred cable conveyance attachment assembly 50 comprises frame 70, chain tensioner 130, mounting plate 150, and flanges 152.

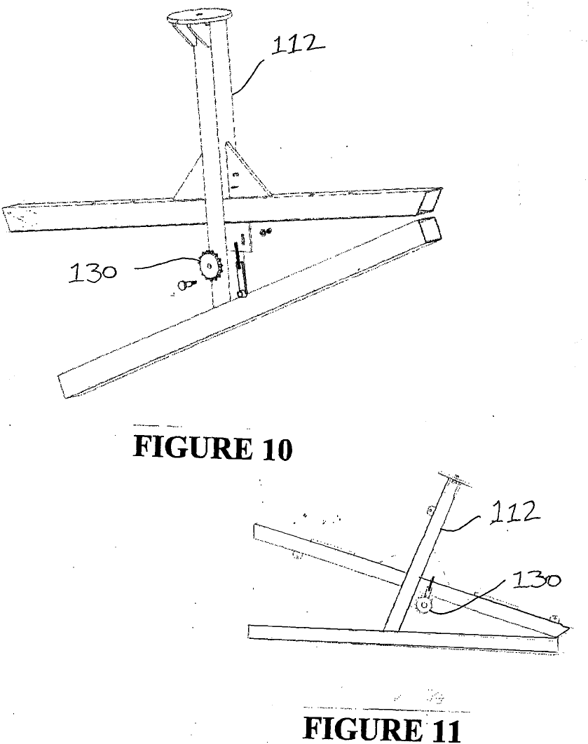

Referring now to FIG. 10, an isolated front perspective view of preferred level wind mount 112 of cable conveyance attachment assembly 50 is illustrated. As shown in FIG. 10, preferred chain tensioner 130 is connected to level wind mount 112.

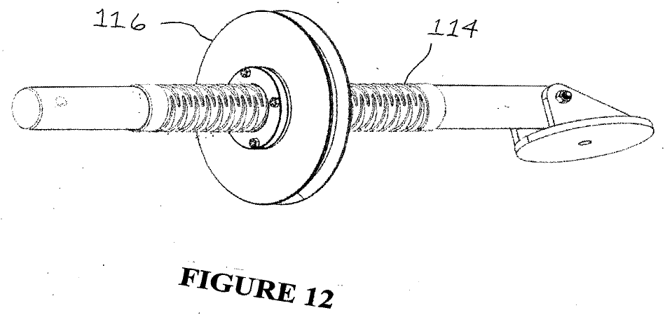

Referring now to FIG. 11, an isolated right side view of preferred level wind mount 112 of cable conveyance attachment assembly 50 is illustrated. As shown in FIG. 11, preferred chain tensioner 130 is connected to level wind mount 112.

Referring now to FIG. 12, an isolated perspective view of preferred threaded shaft 114 and preferred threaded sheave 116 of level wind assembly 110 is illustrated.

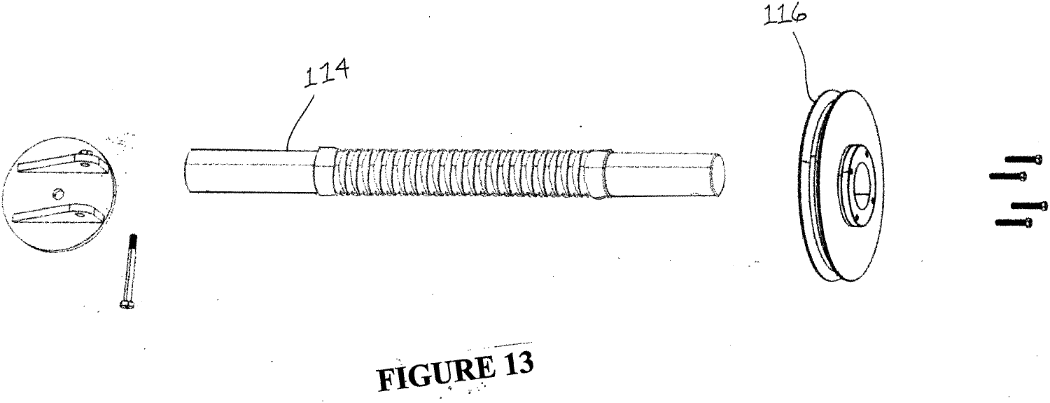

Referring now to FIG. 13, an exploded perspective view of preferred threaded shaft 114 and preferred threaded sheave 116 of level wind assembly 110 is illustrated.

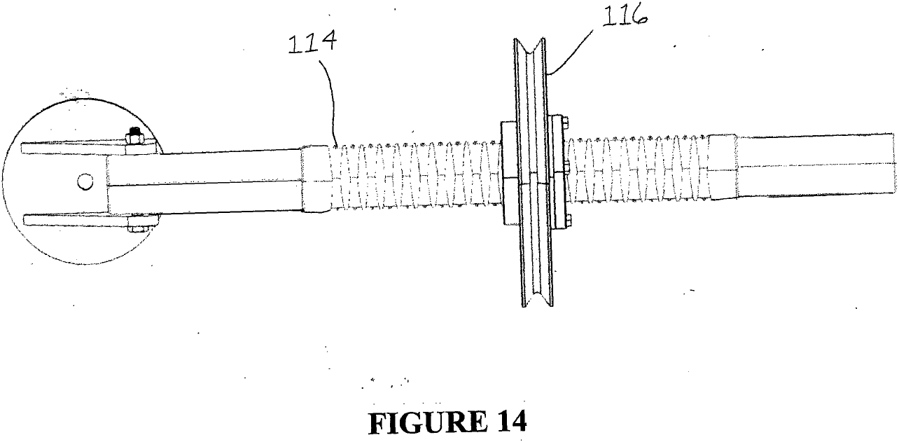

Referring now to FIG. 14, an isolated front view of preferred threaded shaft 114 and preferred threaded sheave 116 of level wind assembly 110 is illustrated.

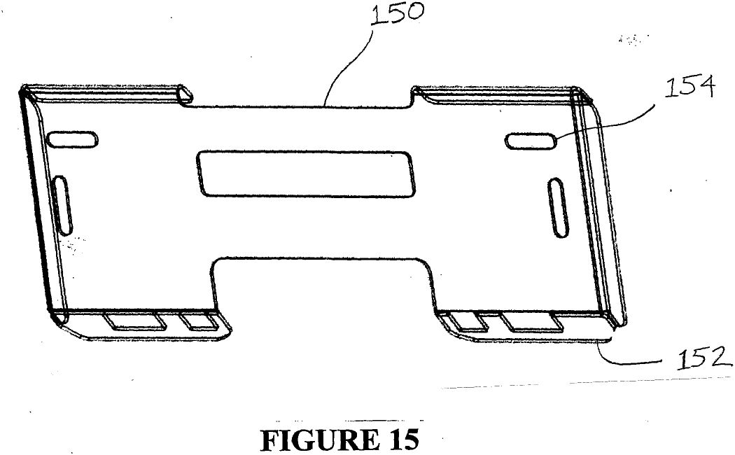

Referring now to FIG. 15, an isolated back perspective view of preferred mounting plate 150 of cable conveyance attachment assembly 50 is illustrated. As shown in FIG. 15, preferred mounting plate 150 comprises flanges 152 and openings 154.

The invention also comprises a method for conveying cable. The preferred method comprises providing a cable conveyance attachment assembly adapted to be operatively connected to a host vehicle and a length of cable. The preferred assembly comprises a frame, a mounting plate that is attached to the frame, at least one drum that is rotationally attached to the frame, and a fluid conduit that is operatively connected to the host vehicle and the at least one drum. Preferably, the at least one drum is adapted to pull the length of cable, and the mounting plate is adapted to removably attach the cable conveyance attachment assembly to the host vehicle. The preferred method further comprises conveying the length of cable to the at least one drum.

In operation, several advantages of the preferred embodiments of the cable conveyance assembly are achieved. For example, the preferred embodiments of the invention claimed herein provide an apparatus and method for a cable conveyance assembly that is sufficiently mobile and transportable. The preferred embodiments of the invention claimed herein also provide an apparatus and method for a cable conveyance assembly that is sufficiently accessible. The preferred embodiments of the invention claimed herein further provide an apparatus and method for a cable conveyance assembly that is sufficiently efficient and requires less time and labor to convey cable. The preferred embodiments of the invention claimed herein still further provide an apparatus and method for a cable conveyance assembly that is less expensive to manufacture, maintain, and repair. In addition, the preferred embodiments of the invention claimed herein provide an apparatus and method for a cable conveyance assembly that requires fewer components, and therefore, is less complex and complicated. The preferred embodiments of the invention claimed herein also provide an apparatus and method for a cable conveyance assembly that does not require an on-board power supply and is less difficult to use and position.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations, and the same are intended to be comprehended within the meaning and range of equivalents of the appended claims.

1. A cable conveyance attachment assembly adapted to be operatively connected to a host vehicle and a length of cable, said assembly comprising:
(a) a frame;
(b) a mounting plate, said mounting plate being attached to the frame;
(c) at least one drum, said at least one drum being rotationally attached to the frame; and
(d) a fluid conduit, said fluid conduit being operatively connected to the host vehicle and the at least one drum;
wherein the at least one drum is adapted to pull the length of cable; and wherein the mounting plate is adapted to removably attach the cable conveyance attachment assembly to the host vehicle.

2. The assembly of claim 1 wherein the host vehicle comprises a wheeled loader.

3. The assembly of claim 1 wherein the host vehicle comprises a tracked loader.

4. The assembly of claim 1 wherein the length of cable is removably stored on a tensioning device.

5. The assembly of claim 1 wherein the mounting plate comprises an attachment means.

6. The assembly of claim 5 wherein the attachment means comprises at least one flange.

7. The assembly of claim 5 wherein the attachment means comprises at least one opening.

8. The assembly of claim 1 wherein the fluid conduit comprises a hydraulic hose, said hydraulic hose having a hydraulic hose first end and a hydraulic hose second end.

9. The assembly of claim 8 wherein the hydraulic hose first end is operatively connected to the host vehicle and the hydraulic hose second end is operatively connected to the at least one drum.

10. The assembly of claim 1 further comprising a level wind assembly.

11. The assembly of claim 10 wherein the level wind assembly comprises a means for adjusting the level wind assembly.

12. The assembly of claim 11 wherein the means for adjusting the level wind assembly includes a threaded shaft.

13. The assembly of claim 11 wherein the means for adjusting the level wind assembly includes a threaded sheave.

14. The assembly of claim 1 further comprising a pulling rope, said pulling rope having a pulling rope first end and a pulling rope second end.

15. The assembly of claim 14 wherein the pulling rope first end is operatively connected to the at least one drum and the pulling rope second end is operatively connected to the length of cable.

16. The assembly of claim 1 further comprising a pulley assembly.

17. The assembly of claim 1 further comprising a block assembly.

18. The assembly of claim 1 further comprising a cable conduit.

19. A cable conveyance system, said cable conveyance system comprising:
(a) a host vehicle;
(b) a tensioning assembly, said tensioning assembly being spaced a distance from the host vehicle and being adapted to removably store a length of cable;
(c) a cable conveyance attachment assembly, said cable conveyance attachment assembly being adapted to be operatively connected to the host vehicle and the length of cable, said cable conveyance attachment assembly comprising:
(i) a frame;
(ii) a mounting plate, said mounting plate being attached to the frame;
(iii) at least one drum, said at least one drum being rotationally attached to the frame;
(iv) a fluid conduit, said fluid conduit being operatively connected to the host vehicle and the at least one drum;
(v) a level wind assembly, said level wind assembly being attached to the frame; and,
(vi) a pulling rope, said pulling rope being attached to the at least one drum;
wherein the at least one drum is adapted to pull the length of cable; and wherein the mounting plate is adapted to removably attach the cable conveyance attachment assembly to the host vehicle.

20. A method for conveying a length of cable, said method comprising:
(a) providing a cable conveyance attachment assembly adapted to be operatively connected to a host vehicle and a length of cable, said assembly comprising:
(i) a frame;
(ii) a mounting plate, said mounting plate being attached to the frame;
(iii) at least one drum, said at least one drum being rotationally attached to the frame; and
(iv) a fluid conduit, said fluid conduit being operatively connected to the host vehicle and the at least one drum;
wherein the at least one drum is adapted to pull the length of cable; and wherein the mounting plate is adapted to removably attach the cable conveyance attachment assembly to the host vehicle; and,
(b) conveying the length of cable to the at least one drum.
